(19) United States
(12) Patent Application Publication
(10) Pub. No.: US 2024/0257100 A1
(43) Pub. Date: Aug. 1, 2024

(54) REAL-TIME TRANSACTIONS USING A VIRTUAL CARD TOKEN

(71) Applicants: American Express Travel Related Services Company, Inc, New York, NY (US); American Express Travel Related Services Company, Inc, New York, NY (US)

(72) Inventors: Lucky A. BIMOLAKSONO, Sydney (AU); Dean Ernest Arthur NICOLSON, Sydney (AU); Margaret H. RYAN, New York, NY (US); Edson MANCILLA, Los Angeles, CA (US)

(73) Assignee: American Express Travel Related Services Company, Inc, New York, NY (US)

(21) Appl. No.: 18/103,867

(22) Filed: Jan. 31, 2023

(51) Int. Cl. G06Q 20/34; G06Q 20/20; G06Q 20/36; G06Q 20/38

(52) U.S. Cl. CPC G06Q 20/351; G06Q 20/20; G06Q 20/36; G06Q 20/3825

(57) ABSTRACT

Disclosed herein are system, method, and computer program product embodiments for providing a virtual card token to facilitate Real-Time Payment (RTP) network transactions. An account management system may facilitate RTP transactions with consumer bank accounts using the virtual card token. After providing the virtual card token to a user device, the user device may present the virtual card token to a merchant system to conduct a transaction. The virtual card token may operate with existing merchant systems and/or point-of-sale (POS) terminals. The merchant system may provide the virtual card token to the account management system for transaction approval. The account management system may select and retrieve funding from a particular bank account based on user-defined parameters. Upon retrieving funding from the particular bank account via the RTP network, the account management system may approve the transaction and/or provide payment to the merchant system.

### BACKGROUND

### Field

This field is generally related to facilitating Real-Time Payment (RTP) transactions using a virtual card token.

### Related Art

As transaction technology continues to evolve, consumers are opting to use mobile devices such as smart phones to perform transactions rather than physical cards. Transaction management for this process, however, is complex when compounded with the scenario where consumers may have multiple accounts that they may wish to use. Consumers using bank accounts for debit card transactions may not be able to perform such transactions using a mobile device. Further, conducting such bank account transactions is a slow process. Accessing funding to complete Automated Clearing House (ACH) transactions may require days of processing. This processing delay results in inefficient transactions and introduces delays into the computational processing time required to authorize a transaction with a merchant system.

### BRIEF SUMMARY

Disclosed herein are system, apparatus, device, method and/or computer program product embodiments, and/or combinations and sub-combinations thereof, for providing a virtual card token to facilitate real-time transactions using a Real-Time Payment (RTP) network.

In some embodiments, an account management system may facilitate the creation of a virtual card token, which may be used to complete transactions via a RTP network. The virtual card token may be data or a data structure corresponding to a user account managed by the account management system. For example, a virtual card token may include a numeric value that may be interpreted by a merchant system or a point of sale (POS) system as a credit card number. When a merchant system receives a virtual card token, the merchant system may treat the virtual card token as if it is receiving a credit card number. For example, the merchant system may provide the virtual card token to the account management system with a transaction amount for transaction authorization. The account management system may then use a RTP network to retrieve funding from a user bank account and authorize the transaction after retrieval. This may increase the speed of transaction authorization due to the speed of the RTP network transaction as further explained below. This may also aid in preventing fraudulent transactions as funding is retrieved prior to approval of the transaction. After authorizing the transaction, the account management system may subsequently transfer funds to a merchant account for the transaction.

In addition to generating a virtual card token, the account management system may provide the virtual card token to a user device. For example, the user device may be a mobile device such as a cellular phone, smart phone, or tablet using an application for storing the virtual card token. Using the virtual card token, a consumer may conduct a transaction with the consumer's user device. For example, the user may hold the user device in close proximity to the merchant system for wireless communication and/or near-field communication of the virtual card token. In some embodiments, the virtual card token may be provided on a physical card, linked to an existing physical card, and/or provided via a visual code. This may provide backwards compatibility with merchant systems.

In some embodiments, the consumer may also use the user device to identify one or more bank accounts and/or set one or more usage parameters for the identified bank accounts. For example, after registering a user account with the account management system, the consumer may identify one or more bank accounts that may be linked to the user account. The one or more bank accounts may correspond to the same and/or different banks or financial institutions. The account management system may validate ownership of the bank accounts and then link them to the user account and/or virtual card token. This linkage may allow the account management system to retrieve transaction funds from the bank accounts for a consumer transaction. In some embodiments, the account management system may retrieve the transaction funds via a RTP network.

In addition to linking one or more bank accounts with the user account managed by the account management system, the consumer may also specify one or more parameters indicating how or when to use each of the one or more bank accounts. For example, the parameters may identify a default bank account for use, set a limit for withdrawal, set a time limit for usage, include an instruction to avoid overdrafting an account, and/or include a personal money management preference for the consumer. For example, the consumer may wish to use one bank account for travel expenses while using a different bank account for groceries and yet another bank account for dining or entertainment. The consumer may specify such usage parameters and inform the account management system.

Upon receipt of the usage parameters, the account management system may store a record in an account database that associates the parameters with the user account, the bank accounts, and/or the virtual card token. Using this record, the account management system may identify the particular bank account to access when the consumer uses the virtual card token to conduct a transaction. The selection of the particular bank account may be based on and/or may be according to parameters defined by the consumer. For example, the user may specify a default or primary bank account and a back-up bank account. When receiving the virtual card token from a merchant system, the account management system may attempt to retrieve funds from the primary bank account. The account management system, however, may determine that such a withdrawal may result in an overdraft of the account. This may be based on a previous limit set by the consumer and/or via communications with a banking system. For example, this may be an API command or call to determine whether an overdraft would occur or to check the account balance. In this case, the account management system may instead withdraw the funding from the back-up bank account.

In some embodiments, the account management system may select a particular bank account for withdrawing funding based on the type of transaction. For example, the user may identify a first bank account for use for household transactions while identifying a second bank account for transit expenses. When the account management system receives the virtual card token, the account management system may also receive an identifier of the type of transaction. For example, the account management system may receive a merchant identification. The account management system may then classify the transaction using the merchant identification. Based on the classification of the transaction, the account management system may select the corresponding bank account for withdrawal.

When withdrawing funding from a bank account, the account management system may use a RTP network. The RTP network may provide real-time payments from banking institutions. The account management system may use an API to connect to and access banking systems via the RTP network. RTP network payments may clear and settle individually in real time with immediate finality. In contrast, same day ACH payments may be cleared in batches and settle after payments clear. In this manner, RTP network access may allow the account management system to more quickly obtain funds for authorizing transactions. The account management system therefore provides a RTP portal for consumer usage. The virtual card token may be a proxy for executing a RTP transaction. The account management system may facilitate such RTP transactions while still following a consumer's preferences based on defined parameters.

This preference management may also provide an enhanced user experience to manage and/or utilize multiple bank accounts for different purposes. This allows fine-tuned management of consumer funding. The account management system may facilitate RTP transactions for each of these bank accounts using a virtual card token. The virtual card token may also be functionality compatible with existing merchant systems and/or POS terminals. In this manner, this virtual card token provides a mechanism for allowing RTP functionality without needing to alter existing merchant systems. The virtual card token reduces complexity in messaging between account management systems and merchant systems when executing RTP transactions. This provides computational processing savings and provides a streamlined way of integrating RTP transactions with existing merchant systems.

Additionally, using a RTP network may reduce and/or prevent fraudulent transactions. Using the RTP network to perform fund transfers allows the account management system to quickly execute and/or verify a transfer of funds from the consumer's bank account. This fast verification may allow the account management system to secure the receipt of funds prior to approving a transaction. This may aid in preventing fraud because funds are actually retrieved prior to approval of a transaction using the virtual card token. Additionally, limiting merchant pull access to bank account numbers and/or details may limit fraud conducted by malicious merchants. This also allows bank fraud monitoring system to also limit fraudulent transactions as bank systems may also decline funding retrieval if fraudulent patterns are detected.

### BRIEF DESCRIPTION OF THE DRAWINGS

The accompanying drawings are incorporated herein and form a part of the specification.

FIG. 1 depicts a block diagram of a virtual card token environment, according to some embodiments.

FIG. 2 depicts a block diagram of a graphical user interface (GUI) displaying bank accounts linked to a virtual card token, according to some embodiments.

FIG. 3 depicts a flowchart illustrating a method for generating a virtual card token, according to some embodiments.

FIG. 4 depicts a flowchart illustrating a method for using a virtual card token on a user device, according to some embodiments.

FIG. 5 depicts a flowchart illustrating authorizing a transaction using a virtual card token, according to some embodiments.

FIG. 6 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a virtual card token to facilitate Real-Time Payment (RTP) network transactions. As further described below, an account management system may facilitate RTP transactions with consumer bank accounts using a virtual card token. The account management system may provide the virtual card token for use on a user device. The user device may present the virtual card token to a merchant system to conduct a transaction. The virtual card token may operate with existing merchant systems and/or point-of-sale (POS) terminals. This may streamline integration of an RTP payment portal with legacy systems. The merchant system may provide the virtual card token to the account management system for transaction approval. The account management system may retrieve funding from a particular bank account based on user-defined parameters. Upon retrieving funding from the particular bank account via the RTP network, the account management system may approve the transaction and/or provide payment to the merchant system.

Various embodiments of these features will now be discussed with respect to the corresponding figures.

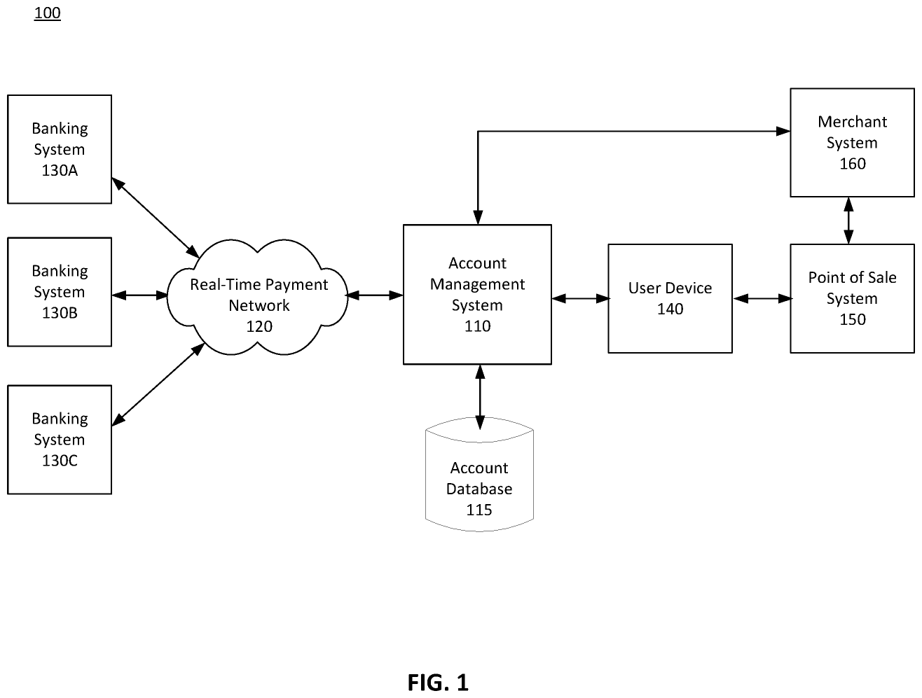

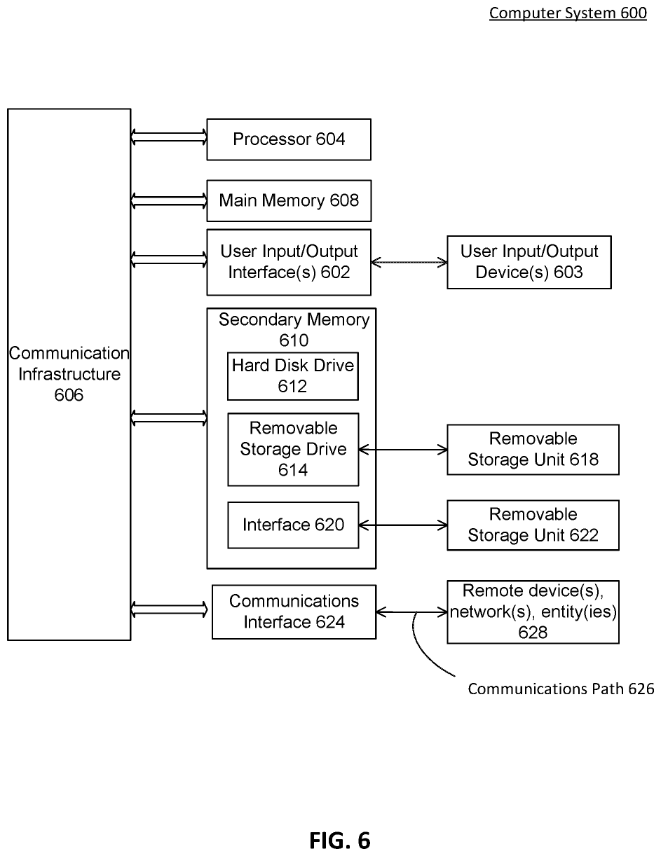

FIG. 1 depicts a block diagram of a virtual card token environment 100, according to some embodiments. Virtual card token environment 100 includes account management system 110, account database 115, Real-Time Payment (RTP) network 120, banking systems 130A, 130B, 130C, user device 140, point of sale (POS) system 150, and/or merchant system 160. Account management system 110 may be a computer system such as computer system 600 described with reference to FIG. 6. For example, account management system 110 may be implemented using one or more servers and/or databases. Account management system 110 may facilitate the registration of a user account and/or linking a user account to one or more bank accounts. Account management system 110 may also receive and/or implement bank account usage preferences specified by a consumer using user device 140. Additionally, account management system 110 may generate a virtual card token for the user account. Account management system 110 may store a record in account database 115 linking the virtual card token to the user account, one or more bank accounts specified by the user, and/or any account usage preferences. In this manner, account management system 110 may facilitate the creation and/or usage of the virtual card token. Account management system 110 may provide the virtual card token to user device 140.

User device 140 may be a computer system such as computer system 600 described with reference to FIG. 6. For example, user device 140 may be a smart phone, smart watch, desktop workstation, laptop or notebook computer, netbook, tablet, personal digital assistant (PDA), and/or other mobile communication devices. User device 140 may include one or more processors and/or memory. User device 140 may communicate with account management system 110 to register a user account, register one or more bank accounts to a user account, and/or provide parameters specifying usage of each of the one or more bank accounts. User device 140 may also receive a virtual card token from account management system 110 and/or store the virtual card token in memory. In some embodiments, user device 140 may be configured to download and/or install a software application to facilitate communications with account management system 110. For example, user device 140 may install the application from account management system 110 and/or an application marketplace or application exchange. User device 140 may communicate with account management system 110 via the Internet.

After receiving a virtual card token, user device 140 may provide the virtual card token to POS system 150 and/or merchant system 160 to conduct a transaction. For example, user device 140 may wirelessly communicate the virtual card token to POS system 150. This may occur when user device 140 is in proximity to POS system 150. For example, user device 140 may communicate the virtual card token to POS system 150 using near-field communications. In some embodiments, user device 140 may communicate the virtual card token from a digital wallet stored on user device 140.

In some embodiments, user device 140 may use a browser and/or communicate the virtual card token to merchant system 160 via a website. This may occur, for example, when a consumer uses user device 140 for online shopping. In some embodiments, if the virtual card token is a numerical value, the user may enter the numeric value into a debit or credit card field on an online shopping website to use the virtual card token.

After receiving the virtual card token from user device 140, merchant system 160 may provide the virtual card token to account management system 110 to authorize the transaction. In some embodiments, merchant system 160 may provide additional information such as a merchant identifier, a transaction type, an itemization of the products or services that the consumer is attempting to purchase, and/or other transaction information. Account management system 110 may use this information to categorize the transaction and/or to select a particular bank account based on previously defined parameters.

After account management system 110 receives the virtual card token from merchant system 160, account management system 110 may search account database 115 using the virtual card token to identify the corresponding user account. Account management system 110 may also identify one or more bank accounts associated with the user account and/or one or more usage parameters. Using these usage parameters, account management system 110 may identify a particular bank account to use to complete the transaction. For example, the consumer may have previously identified a first bank account for travel expenses, a second bank account for groceries, and a third bank account for dining or entertainment. Based on the transaction type, account management system 110 may identify a particular bank for withdrawing funds for the transaction. In some embodiments, the usage parameters may indicate a default bank account for usage. There may be parameters defining use of this default bank account. For example, there may be a withdrawal limit and/or a time limit for usage. In some embodiments, account management system 110 may identify a back-up bank account. This back-up bank account may be used when a primary or default bank account is unavailable and/or when the parameters prevent usage of the primary or default bank account.

After selecting the particular bank account for the transaction, account management system 110 may access a banking system 130 via RTP network 120. For example, this access may be an API command or call issued by account management system 110 to access the consumer's bank account. Funding may be retrieved via RTP network 120. As previously explained, this retrieval of funding may be faster than ACH retrieval and/or may result in account management system 110 accessing the funds in a faster manner. In some embodiments, account management system 110 may use RTP network 120 to direct funding from the consumer's account into an account corresponding to account management system 110. For example, if a consumer's account corresponds to banking system 130A and an account corresponding to account management system 110 corresponds to banking system 130B, account management system 110 may direct a transfer from banking system 130A to banking system 130B. Account management system 110 may specify the appropriate account numbers for this transfer.

By using RTP network 120 to perform this fund transfer, account management system 110 may quickly execute and/or verify a transfer of funds from the consumer's bank account. This fast verification may allow account management system 110 to secure the receipt of funds prior to approving a transaction. This may aid in preventing fraud as well because funds are actually retrieved prior to approval of a transaction using the virtual card token.

After retrieving the funds from the consumer's designated bank account, account management system 110 may approve and/or authorize the transaction. For example, account management system 110 may transmit a notification to merchant system 160 indicating that the transaction has been approved. Merchant system 160 may indicate this approval via a display on POS system 150. The consumer may then be allowed to leave the merchant premises with the transaction completed.

After approving the transaction, account management system 110 may credit the transaction amount to a merchant account. In some embodiments, this may occur after transaction approval. For example, account management system 110 may perform a next day clearing. In this manner, the approval of the transaction may still be streamlined for completing the user transaction while transfer of funding to a merchant account may occur at a later time. In some embodiments, account management system 110 may use RTP network 120 to transfer funds from an account corresponding to account management system 110 to a merchant account. For example, if a merchant account corresponds to banking system 130C and an account corresponding to account management system 110 corresponds to banking system 130B, account management system 110 may direct a transfer of funds from banking system 130B to banking system 130C. Account management system 110 may specify the appropriate account numbers for this transfer.

In some embodiments, account management system 110 may direct funds from a customer account managed by banking system 130A directly to a merchant account corresponding to banking system 130C. Account management system 110 may direct funding and/or transaction fees depending on the transferring of funding between banking system 130. For example, account management system 110 may charge and/or debit a merchant account with fees. The fee charging and/or debiting may occur on a periodic basis.

In this manner, account management system 110 may facilitate the management of user bank accounts and/or the use virtual card tokens to provide RTP transactions. This may provide a RTP portal to provide RTP transactions to a POS system 150 and/or merchant system 160. As previously explained, because a virtual card token may be data appearing as a credit card, alterations of existing and/or legacy POS systems 150 and/or merchant system 160 may be avoided. This may allow for streamlined integration of RTP transactions into existing systems.

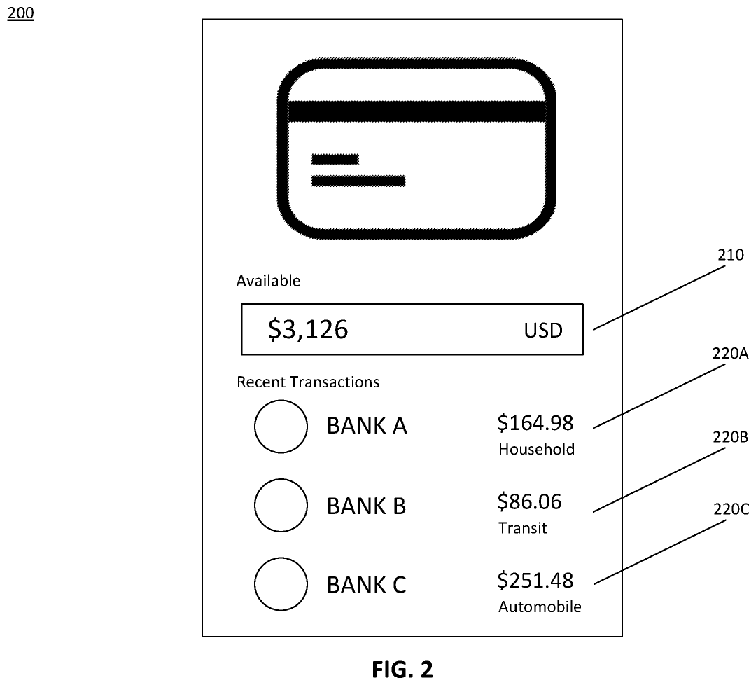

FIG. 2 depicts a block diagram of a graphical user interface (GUI) 200 displaying bank accounts linked to a virtual card token, according to some embodiments. GUI 200 may be generated by account management system 110 and/or may be displayed via user device 140. For example, GUI 200 may be a screen from an application installed on user device 140. In some embodiments, user device 140 may access a website and/or webpage to view GUI 200. Account management system 110 may provide GUI data objects and/or data to user device 140 to display GUI 200.

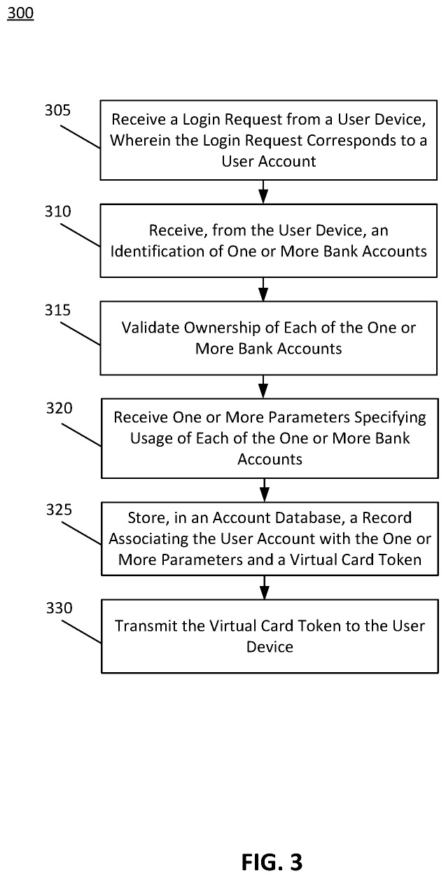

GUI 200 may include a visual indication of the virtual card token. For example, GUI 200 may display an image depicting the virtual card token. In some embodiments, if the virtual card token includes a numerical value, GUI 200 may also display this numerical value. The user may then use this numerical value with a merchant system 160 to conduct a transaction. GUI 200 may also include an account balance 210. Account balance 210 may indicate a sum of available account funding. This may be a sum across one or more bank accounts identified by the consumer as belonging to the consumer. As will be further explained with reference to FIG. 3, a user may perform a validation process using user device 140 and/or account management system 110 to register one or more bank accounts for usage. In some embodiments, the user may provide permissions to account management system 110 to query one or more of the bank accounts to retrieve account balance information. In this manner, account management system 110 may periodically update the account balance 210 displayed on GUI 200 with an amount reflecting one or more bank accounts.

GUI 200 may also include one or more transaction data objects 220. The transaction data objects 220 may be displayed icons, data, images, and/or other GUI objects that identify transactions corresponding to the user account accessing GUI 200. For example, transaction data objects 220 may be arranged chronologically. This may display recent transactions using the virtual card token. Each transaction data object 220 may include an identification of a particular bank, bank account, transaction amount, transaction date and/or time, transaction type, merchant, and/or other transaction information. In some embodiments, transaction data objects 220 may correspond to transactions with different bank accounts from different banks. In this manner, GUI 200 may display multiple transactions from different bank accounts used by the consumer. Account management system 110 may facilitate the linking of such accounts and/or tracking of transactions corresponding to the accounts.

FIG. 3 depicts a flowchart illustrating a method 300 for generating a virtual card token, according to some embodiments. Method 300 shall be described with reference to FIG. 1, however, method 300 is not limited to that example embodiment.

In an embodiment, account management system 110 may utilize method 300 to link one or more bank accounts to a user account and generate a virtual card token for the user account. This linking may also account for usage parameters defined to identify a particular bank account for use. The foregoing description will describe an embodiment of the execution of method 300 with respect to account management system 110. While method 300 is described with reference to account management system 110, method 300 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3, as will be understood by a person of ordinary skill in the art. At 305, account management system 110 may receive a login request from a user device 140, wherein the login request corresponds to a user account. For example, user device 140 may provide login credentials such as a user name and password corresponding to the user account. Account management system 110 may verify the login credentials using data stored in account database 115. Upon verifying the credentials, account management system 110 may provide access to the virtual card token creation process. For example, account management system 110 may provide access to application features installed on user device 140. Account management system 110 may also provide an Internet communication interface to access bank account and/or virtual card token information. In some embodiments, account management system 110 may facilitate the creation of the user account as well. For example, account management system 110 may implement a Know Your Customer (KYC) onboarding process. The onboarding process may include requesting the user to submit user information, a name, address, social security number, an image of an identification, an image of the user or a likeness, and/or other personal user data.

At 310, account management system 110 may receive, from user device 140, an identification of one or more bank accounts. The identification of one or more bank accounts may indicate the bank accounts to be linked to the virtual card token that will be generated by account management system 110. To identify or add a bank account, a user may interface with a display screen provided on user device 140. This may be accessible via an application or web browser and may allow the user to provide information to account management system 110. The user may identify the bank account using a routing number and/or an account number. In some embodiments, the user may specify the particular bank. For example, the application may display a list of banks for the user to choose. After selecting the bank, the user may provide login credentials for that bank. Account management system 110 may then retrieve and generate a list of bank accounts corresponding to those login credentials. The user may then select the desired bank account.

At 315, account management system 110 may validate the ownership of each of the one or more bank accounts specified by the user. For example, account management system 110 may perform a penny drop verification process where a number of cents are transferred to the account. This may be performed via RTP network 120. The user may then be requested to confirm the amount transferred to verify ownership of the bank account. In some embodiments, account management system 110 may request that the user submit a government identification and/or an image of the user's likeness. For example, the user may submit an image using user device 140. This image capture may be performed within the application stored on user device 140 that is used to communicate with account management system 110. In some embodiments, account management system 110 may obtain validation from a banking system 130. For example, account management system 110 may obtain validation from an open banking framework. For example, open banking consent processes may be used to validate a bank account.

Upon validating ownership of a bank account, account management system 110 may store a record associating the one or more bank accounts with the user account in account database 115. Linking the one or more bank accounts may allow the user to view the bank accounts via an application or web browser on user device 140. In some embodiments, account management system 110 may periodically retrieve account balances for the one or more bank accounts and/or display the retrieved account balances.

At 320, account management system 110 may receive one or more parameters specifying usage of each of the one or more bank accounts. The parameters may indicate the particular bank account to use for a transaction. For example, the parameters may identify a default bank account for use, set a limit for withdrawal, set a time limit for usage, include an instruction to avoid overdrafting an account, and/or include a personal money management preference for the consumer. The user may specify a default or primary bank account and a back-up bank account. When resolving transactions, account management system 110 may attempt to use the primary bank account unless there is a restriction such as an overdraft limit. For example, account management system 110 may compare a transaction amount to a limit and determine that the transaction amount exceeds the limit. In this case, account management system 110 may select and use the back-up bank account. Similarly, the user may set a time limit such as 90 days to use the primary bank account. When that time limit expires, account management system 110 may resolve transactions using the back-up bank account. In some embodiments, the back-up bank account may be designated as an account where the user is receiving an income and/or direct deposits.

In some embodiments, the one or more parameters may specify the bank account to use based on the type of transaction conducted. For example, the consumer may wish to use one bank account for travel expenses while using a different bank account for groceries and yet another bank account for dining or entertainment. Similarly, the user may identify a first bank account for household transactions while identifying a second bank account for transit expenses. When account management system 110 later receives the virtual card token, account management system 110 may also receive an identifier of the type of transaction. For example, account management system 110 may receive a merchant identification. Account management system 110 may then classify the transaction using the merchant identification. Based on the classification of the transaction, account management system 110 may select the corresponding bank account for withdrawal. This may allow the user to personalize bank account usage.

To provide these parameters, the user may interact with an application and/or web browser operating on user device 140. For example, the user may select from pre-defined parameters provided by account management system 110. This may include a selection of boxes and/or drop-down menus. In some embodiments, the user may provide a specification in written form. Account management system 110 may analyze such written requests to generate and/or identify the parameters.

At 325, account management system 110 may store, in account database 115, a record associating the user account with the one or more parameters and a virtual card token. Account management system 110 may generate the virtual card token for the user account. This virtual card token may be used to complete transactions. Account management system 110 may link this virtual card token with the one or more bank accounts and/or the one or more parameters specified by the user. This database record may be used when resolving a transaction. Upon receiving the virtual card token, account management system 110 may use the virtual card token as a look-up to identify the user account, the one or more bank accounts, and/or the one or more parameters. Account management system 110 may then select the particular bank account to use according to the one or more parameters.

At 330, account management system 110 may transmit the virtual card token to user device 140. For example, account management system 110 may provide the virtual card token for storage in memory at user device 140. The virtual card token may be a data structure and/or data object stored in a digital wallet of user device 140. User device 140 may be able to provide the virtual card token to a POS system 150 to conduct transactions.

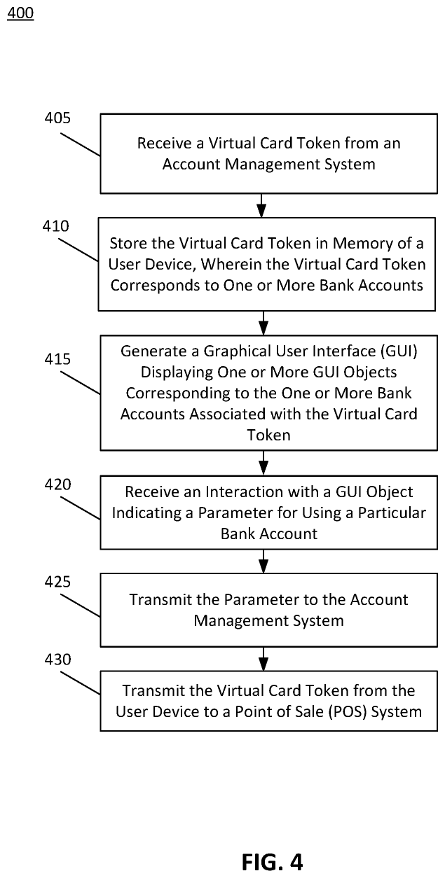

FIG. 4 depicts a flowchart illustrating a method for using a virtual card token on a user device, according to some embodiments. Method 400 shall be described with reference to FIG. 1, however, method 400 is not limited to that example embodiment.

In an embodiment, user device 140 may utilize method 400 to store and use a virtual card token. The foregoing description will describe an embodiment of the execution of method 300 with respect to user device 140. While method 400 is described with reference to user device 140, method 400 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4, as will be understood by a person of ordinary skill in the art.

At 405, user device 140 may receive a virtual card token from an account management system 110. A user may have identified one or more bank accounts corresponding to a user account as discussed with reference to FIG. 3. Account management system 110 may then generate and transmit a virtual card token to user device 140. This may be a data structure communicated to user device 140 via the Internet.

At 410, user device 140 may store the virtual card token in the memory of the user device 140. The virtual card token may correspond to one or more bank accounts. This may have been previously specified by the user to account management system 110 as described with reference to FIG. 3. In some embodiments, the memory of the user device may be a digital wallet. The digital wallet may be the same application being used to communicate with account management system 110 and/or a different application. For example, the application may be a separate mobile payment application.

At 415, user device 140 may generate a graphical user interface (GUI) displaying one or more GUI objects corresponding to the one or more bank accounts associated with the virtual card token. Account management system 110 may provide data that user device 140 may use to generate the GUI. In some embodiments, the GUI may allow the user to view bank accounts previously identified and/or validated as described with reference to FIG. 3. In some embodiments, a user may navigate to and/or access GUI 200, described with reference to FIG. 2, using this GUI. The one or more GUI objects may include buttons, icons, and/or other graphical components allowing a user to provide interactions.

At 420, user device 140 may receive an interaction with a GUI object indicating a parameter for using a particular bank account. This parameter may be similar to the one or more parameters described with reference to 320 from FIG. 3. To provide these parameters, the user may interact with an application and/or web browser operating on user device 140. For example, the user may select from pre-defined parameters provided by account management system 110. This may include a selection of boxes and/or drop-down menus. In some embodiments, the user may provide a specification in written form. Account management system 110 may analyze such written requests to generate and/or identify the parameters. In some embodiments, the parameter may arrange the one or more bank accounts in a particular order for usage. For example, the interaction may be modifying an ordered list to identify a priority of bank account usage. As previously explained, a parameter may also include identifying a particular bank account to use for a particular type of transaction. For example, a parameter may specify that a first bank account should be used for entertainment transactions while a second bank account should be a default bank account used for other transactions. At 420, a user may also modify existing parameters to change the selection of the particular bank account for use.

At 425, user device 140 may transmit the parameter to the account management system 110. Account management system 110 may receive and/or store the parameter as described with reference to 320 and 325 from FIG. 3. This may be an initial designation of usage parameters and/or an update of usage parameters. As previously explained, account management system 110 may associate the usage parameters with the user account and execute a transaction with the virtual card token according to the parameters.

At 430, user device 140 may transmit the virtual card token from user device 140 to a POS system 150. This may occur when a consumer uses user device 140 to conduct a transaction. For example, the user may hold user device 140 in close proximity to POS system 150 and/or merchant system 160 for wireless communication and/or near-field communication of the virtual card token. In some embodiments, user device 140 may communicate the virtual card token from a digital wallet stored on user device 140. In some embodiments, user device 140 may use a browser and/or communicate the virtual card token to merchant system 160 via a website. This may occur, for example, when a consumer uses user device 140 for online shopping. In some embodiments, if the virtual card token is a numerical value, the user may enter the numeric value into a debit or credit card field to use the virtual card token.

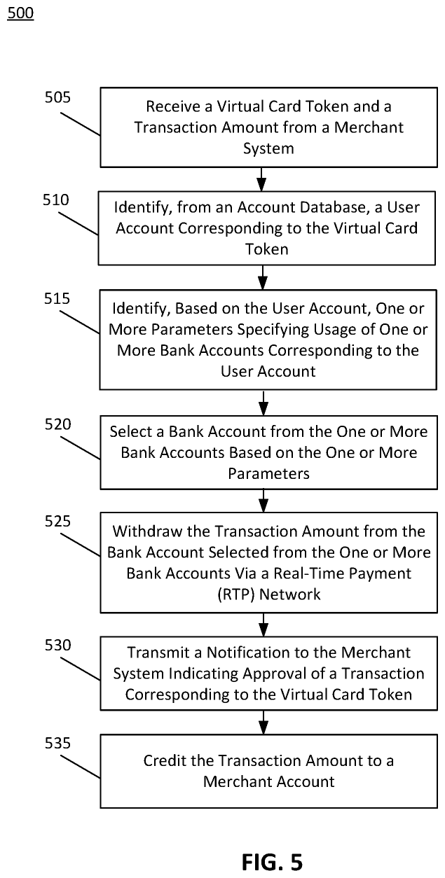

FIG. 5 depicts a flowchart illustrating authorizing a transaction using a virtual card token, according to some embodiments. Method 500 shall be described with reference to FIG. 1, however, method 500 is not limited to that example embodiment.

In an embodiment, account management system 110 may utilize method 500 to execute a transaction in response to receiving a virtual card token from a merchant system 160. The foregoing description will describe an embodiment of the execution of method 500 with respect to account management system 110. While method 500 is described with reference to account management system 110, method 500 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 5, as will be understood by a person of ordinary skill in the art.

At 505, account management system 110 may receive a virtual card token and a transaction amount from a merchant system 160. For example, a user may have used user device 140 to conduct a transaction with POS system 150. POS system 150 may receive the virtual card token from user device 140. POS system 150 and/or merchant system 160 may then transmit the virtual card token to merchant system 160.

At 510, account management system 110 may identify a user account corresponding to the virtual card token from account database 115. As previously described with reference to 325, account management system 110 may have stored a record associating the virtual card token with a user account, one or more bank accounts, and/or one or more parameters. Account management system 110 may use the received virtual card token to perform a look-up to identify the particular user account and its corresponding bank account and parameter data. This may be a database look-up.

At 515, account management system 110 may identify, based on the user account, one or more parameters specifying usage of one or more bank accounts corresponding to the user account. As previously described with reference to 325, a user may have defined parameters for selecting a particular bank account for use. For example, the parameters may identify a default bank account for use, set a limit for withdrawal, set a time limit for usage, include an instruction to avoid overdrafting an account, and/or include a personal money management preference for the consumer. For example, the parameters may identify a particular bank account for use depending on the transaction type. Account management system 110 may categorize a transaction based on merchant identification data, determine that a categorized transaction type of the transaction matches the transaction type corresponding to the bank account, and then select the bank account corresponding to the transaction type. In some embodiments, the user may define rules, a decision flow, and/or an algorithm for determining the particular bank account to select.

At 520, account management system 110 may select a bank account from the one or more bank accounts based on the one or more parameters. For example, the account management system 110 may apply the rules, flow, and/or algorithm previously defined to select the particular bank account to use to complete the transaction.

At 525, account management system 110 may withdraw the transaction amount from the bank account selected from the one or more bank accounts via a Real-Time Payment (RTP) network 120. RTP network 120 may provide real-time payments from banking systems 130. Account management system 110 may use an API to connect to and access banking systems 130 via the RTP network 120. In some embodiments, account management system 110 may use RTP network 120 to direct funding from the consumer's account into an account corresponding to account management system 110. For example, if a consumer's account corresponds to banking system 130A and an account corresponding to account management system 110 corresponds to banking system 130B, account management system 110 may direct a transfer from banking system 130A to banking system 130B. Account management system 110 may specify the appropriate account numbers for this transfer.

At 530, account management system 110 may transmit a notification to merchant system 160 indicating approval of a transaction corresponding to the virtual card token. After retrieving the funds from the consumer's designated bank account, account management system 110 may approve and/or authorize the transaction. For example, account management system 110 may transmit a notification to merchant system 160 indicating that the transaction has been approved. Merchant system 160 may indicate this approval via a display on POS system 150. The consumer may then be allowed to leave the merchant premises with the transaction completed.

At 535, account management system 110 may credit the transaction amount to a merchant account. In some embodiments, this may occur after transaction approval. For example, account management system 110 may perform a next day clearing. In this manner, the approval of the transaction may still be streamlined for completing the user transaction while transfer of funding to a merchant account may occur at a later time. In some embodiments, account management system 110 may use RTP network 120 to transfer funds from an account corresponding to account management system 110 to a merchant account. For example, if a merchant account corresponds to banking system 130C and an account corresponding to account management system 110 corresponds to banking system 130B, account management system 110 may direct a transfer from banking system 130B to banking system 130C. Account management system 110 may specify the appropriate account numbers for this transfer.

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method, comprising:
receiving a virtual card token and a transaction amount from a merchant point-of-sale system;
identifying, from an account database, a user account corresponding to the virtual card token;
identifying, based on the user account, one or more parameters specifying usage of one or more bank accounts corresponding to the user account;
selecting a bank account from the one or more bank accounts based on the one or more parameters;
withdrawing the transaction amount from the bank account selected from the one or more bank accounts via a Real-Time Payment (RTP) network; and
in response to withdrawing the transaction amount, transmitting a notification to the merchant point-of-sale system indicating approval of a transaction corresponding to the virtual card token.

2. The computer implemented method of claim 1, wherein the one or more parameters identify a first bank account, a second bank account, and a limit for using the first bank account, and wherein selecting the bank account further comprises:
comparing the transaction amount to the limit;
determining that the transaction amount exceeds the limit; and
in response to the determining, selecting the second bank account.

3. The computer implemented method of claim 1, wherein the one or more parameters identify a transaction type corresponding to the bank account selected from the one or more bank accounts, and wherein selecting the bank account further comprises:
categorizing the transaction based on merchant identification data;
determining that a categorized transaction type of the transaction matches the transaction type corresponding to the bank account; and
in response to the determining, selecting the second bank account.

4. The computer implemented method of claim 1, wherein withdrawing the transaction amount further comprises:
transmitting an API command to the RTP network to transfer the transaction amount from the bank account selected from the one or more bank accounts to a second bank account via the RTP network.

5. The computer implemented method of claim 1, further comprising:
receiving, from a user device, an identification of the one or more bank accounts; and
receiving the one or more parameters specifying usage of the one or more bank accounts;
storing, in the account database, a record associating the user account with the virtual card token, the one or more bank accounts, and the one or more parameters; and
transmitting the virtual card token to the user device.

6. The computer implemented method of claim 1, further comprising:
transmitting the virtual card token to a digital wallet on a user device used to interact with the merchant point-of-sale system.

7. The computer implemented method of claim 1, further comprising:
receiving the virtual card token and a second transaction amount from an online shopping website;
identifying the user account corresponding to the virtual card token;
identifying, based on the user account, the one or more parameters specifying usage of the one or more bank accounts;
selecting a second bank account from the one or more bank accounts based on the one or more parameters;
withdrawing the second transaction amount from the second bank account selected from the one or more bank accounts via the RTP network; and
in response to withdrawing the second transaction amount, transmitting a notification to the online shopping website indicating approval of an online transaction corresponding to the virtual card token.

8. A system, comprising:
a memory; and
at least one processor coupled to the memory and configured to:
receive a virtual card token and a transaction amount from a merchant point-of-sale system;
identify, from an account database stored in the memory, a user account corresponding to the virtual card token;
identify, based on the user account, one or more parameters specifying usage of one or more bank accounts corresponding to the user account;
select a bank account from the one or more bank accounts based on the one or more parameters;
withdraw the transaction amount from the bank account selected from the one or more bank accounts via a Real-Time Payment (RTP) network; and
in response to withdrawing the transaction amount, transmit a notification to the merchant point-of-sale system indicating approval of a transaction corresponding to the virtual card token.

9. The system of claim 8, wherein the one or more parameters identify a first bank account, a second bank account, and a limit for using the first bank account, and wherein the at least one processor is further configured to:
compare the transaction amount to the limit;
determine that the transaction amount exceeds the limit; and
in response to the determining, select the second bank account.

10. The system of claim 8, wherein the one or more parameters identify a transaction type corresponding to the bank account selected from the one or more bank accounts, and wherein the at least one processor is further configured to:
categorize the transaction based on merchant identification data;
determine that a categorized transaction type of the transaction matches the transaction type corresponding to the bank account; and
in response to the determining, select the second bank account.

11. The system of claim 8, wherein to withdraw the transaction amount, the at least one processor is further configured to:
transmit an API command to the RTP network to transfer the transaction amount from the bank account selected from the one or more bank accounts to a second bank account via the RTP network.

12. The system of claim 8, wherein the at least one processor is further configured to:
receive, from a user device, an identification of the one or more bank accounts; and
receive the one or more parameters specifying usage of the one or more bank accounts;
store, in the account database, a record associating the user account with the virtual card token, the one or more bank accounts, and the one or more parameters; and
transmit the virtual card token to the user device.

13. The system of claim 8, wherein the at least one processor is further configured to:
transmit the virtual card token to a digital wallet on a user device used to interact with the merchant point-of-sale system.

14. The system of claim 8, wherein the at least one processor is further configured to:
receive the virtual card token and a second transaction amount from an online shopping website;
identify the user account corresponding to the virtual card token;
identify, based on the user account, the one or more parameters specifying usage of the one or more bank accounts;
select a second bank account from the one or more bank accounts based on the one or more parameters;
withdraw the second transaction amount from the second bank account selected from the one or more bank accounts via the RTP network; and
in response to withdrawing the second transaction amount, transmit a notification to the online shopping website indicating approval of an online transaction corresponding to the virtual card token.

15. A non-transitory computer-readable device having instructions stored thereon that, when executed by at least one computing device, cause the at least one computing device to perform operations comprising:
receiving a virtual card token and a transaction amount from a merchant point-of-sale system;
identifying, from an account database, a user account corresponding to the virtual card token;
identifying, based on the user account, one or more parameters specifying usage of one or more bank accounts corresponding to the user account;
selecting a bank account from the one or more bank accounts based on the one or more parameters;
withdrawing the transaction amount from the bank account selected from the one or more bank accounts via a Real-Time Payment (RTP) network; and
in response to withdrawing the transaction amount, transmitting a notification to the merchant point-of-sale system indicating approval of a transaction corresponding to the virtual card token.

16. The non-transitory computer-readable device of claim 15, wherein the one or more parameters identify a first bank account, a second bank account, and a limit for using the first bank account, and wherein selecting the bank account further comprises:
comparing the transaction amount to the limit;
determining that the transaction amount exceeds the limit; and
in response to the determining, selecting the second bank account.

17. The non-transitory computer-readable device of claim 15, wherein the one or more parameters identify a transaction type corresponding to the bank account selected from the one or more bank accounts, and wherein selecting the bank account further comprises:
categorizing the transaction based on merchant identification data;
determining that a categorized transaction type of the transaction matches the transaction type corresponding to the bank account; and
in response to the determining, selecting the second bank account.

18. The non-transitory computer-readable device of claim 15, wherein withdrawing the transaction amount further comprises:
transmitting an API command to the RTP network to transfer the transaction amount from the bank account selected from the one or more bank accounts to a second bank account via the RTP network.

19. The non-transitory computer-readable device of claim 15, the operations further comprising:
receiving, from a user device, an identification of the one or more bank accounts;
receiving the one or more parameters specifying usage of the one or more bank accounts;
storing, in the account database, a record associating the user account with the virtual card token, the one or more bank accounts, and the one or more parameters; and
transmitting the virtual card token to the user device.

20. The non-transitory computer-readable device of claim 15, the operations further comprising:
transmitting the virtual card token to a digital wallet on a user device used to interact with the merchant point-of-sale system.
